(19) United States
(12) Patent Application Publication
(10) Pub. No.: US 2013/0031636 A1
(43) Pub. Date: Jan. 31, 2013

(54) SECURE GAME SCRAMBLER

(71) Applicants: Nathan Altschul, New York, NY (US); Dhimiter Bozo, Brooklyn, NY (US); Pier Borra, Summit, NJ (US)

(72) Inventors: Nathan Altschul, New York, NY (US); Dhimiter Bozo, Brooklyn, NY (US); Pier Borra, Summit, NJ (US)

(73) Assignee: Viacom International Inc., New York, NY (US)

(21) Appl. No.: 13/193,134

(22) Filed: Jul. 28, 2011

(51) Int. Cl. G06F 21/24; G06F 17/30

(52) U.S. Cl. 726/26

(57) ABSTRACT

A computer-implemented method is disclosed for providing content protection to a data file displayed on a webpage. The method includes scrambling, by a scrambling module, data in the data file to produce a scrambled data file. The scrambled data file is stored in a storage module. A computing device embeds a wrapper file associated with the scrambled data file into the webpage that, upon loading, retrieves the scrambled data file from the storage module and descrambles data in the scrambled data file.

### FIELD OF THE INVENTION

The technology generally relates to systems and methods for online content protection.

### BACKGROUND OF THE INVENTION

The Internet is a convenient and popular content distribution medium that provides users with near instant access to digital content. In many instances, users have complete control over the hardware and software used to access digital content, thus making the content vulnerable to attempts to bypass content protection mechanisms maintained by content providers. One possible security concern is hotlinking, which involves the use of a linked object from a webpage to a host site where the object is stored. Hotlinking can be problematic because the host site may not have authorized the new placement. Hotlinking can also increase the bandwidth usage of the host site even though the host site is not being viewed as intended. Such hostile environment can pose a challenge to content providers who are concerned about providing secured access to digital content.

### SUMMARY OF THE INVENTION

Systems and methods are disclosed for protecting the content of a data file displayed on a webpage. The systems and methods are advantageous because they offer protection against intrusions in the form of hotlinking or decompilation, for example. In addition, they are easy to deploy, easy to integrate into existing processes, and minimally disruptive to the operation of a webpage while offering substantial protection against content piracy.

In one aspect, the invention features a method, executed on a computer, for providing content protection to a data file displayed on a webpage. The method includes scrambling, by a scrambling module, data in the data file to produce a scrambled data file. The method also includes storing, by a storage module, the scrambled data file. The method further includes embedding, by a computing device, a wrapper file associated with the scrambled data file into the webpage that, upon loading, retrieves the scrambled data file from the storage module and descrambles data in the scrambled data file.

In another aspect, the invention features a method, executed on a computer, for providing content protection to a data file displayed on a webpage. The method includes loading, by a computing device, the webpage having a wrapper file embedded therein. The wrapper file is associated with a scrambled data file produced from scrambling data in the data file. The method also includes retrieving, by a retrieval module, the scrambled data file from a storage module. The method further includes descrambling, by a descrambling module, data in the scrambled data file. In some embodiments, the method can further include triggering, by an execution module, execution of the wrapper file that initiates the retrieving and the descrambling.

In another aspect, the invention features a method for providing content protection to a data file displayed on a webpage. The method includes scrambling, by a scrambling module, data in the data file to produce a scrambled data file. The method also includes storing, by a storage module, the scrambled data file and embedding, by a first computing device, a wrapper file associated with the scrambled data file into the webpage. The method further includes loading, by a second computing device, the webpage, retrieving, by a retrieval module, the scrambled data file from the storage module, and descrambling, by a descrambling module, data in the scrambled data file.

In another aspect, the invention features a computing system for providing content protection to a data file displayed on a webpage. The computing system includes a scrambling module for scrambling data in the data file to produce a scrambled data file. The computing system also includes a storage module for storing the scrambled data file. The computing system further includes a computing device for embedding a wrapper file associated with the scrambled data file into the webpage that, upon loading, retrieves the scrambled data file from the storage module and descrambles data in the scrambled data file.

In another aspect, the invention features a computing system for providing content protection to a data file displayed on a webpage. The computing system includes a computing device for loading the webpage having a wrapper file embedded therein. The wrapper file is associated with a scrambled data file produced from scrambling data in the data file. The computing system also includes a retrieval module for retrieving the scrambled data file from a storage module. The computing system further includes a descrambling module for descrambling data in the scrambled data file.

In another aspect, the invention features a computer program product, tangibly embodied in a non-transitory computer readable medium, for providing content protection to a data file displayed on a webpage. The computer program product includes instructions being operable to cause data processing apparatus to scramble data in the data file to produce a scrambled data file, store the scrambled data file in a storage module, and embed a wrapper file associated with the scrambled data file into the webpage that, upon loading, retrieves the scrambled data file from the storage module and descrambles data in the scrambled data file.

In yet another aspect, the invention features a computer program product, tangibly embodied in a non-transitory computer readable medium, for providing content protection to a data file displayed on a webpage. The computer program product includes instructions being operable to cause data processing apparatus to load the webpage having a wrapper file embedded therein. The wrapper file is associated with a scrambled data file produced from scrambling data in the data file. The computer program product also includes instructions being operable to cause data processing apparatus to retrieve the scrambled data file from a storage module, and descramble data in the scrambled data file.

In other examples, any of the aspects above can include one or more of the following features. In some embodiments, scrambling the data in the data file includes encrypting the data. In some embodiments, descrambling the data in the scrambled data file includes decrypting the data.

In some embodiments, the wrapper file includes a link to the scrambled data file stored in the storage module. In some embodiments, the wrapper file includes a descrambling code for descrambling the data in the scrambled data file. The wrapper file can be obfuscated to conceal the descrambling code.

In some embodiments, at least one of the data file, the scrambled data file, or the wrapper file is in a SWF format.

In some embodiments, a domain name associated with the webpage is validated to ensure that the domain name is on a list of approved domain names before loading the webpage.

In some embodiments, the wrapper file is prevented from being executed from a local cache location.

### BRIEF DESCRIPTION OF THE DRAWINGS

The advantages of the technology described above, together with further advantages, may be better understood by referring to the following description taken in conjunction with the accompanying drawings. The drawings are not necessarily to scale, emphasis instead generally being placed upon illustrating the principles of the technology.

FIG. 1 shows an exemplary network environment according to some embodiments of the technology.

FIG. 2A shows an exemplary process executed by a first computing device.

FIG. 2B shows an exemplary process for encrypting the content of a data file.

FIG. 3A shows an exemplary process executed by a second computing device.

FIG. 3B shows an exemplary process for decrypting the content of a data file.

### DETAILED DESCRIPTION OF THE INVENTION

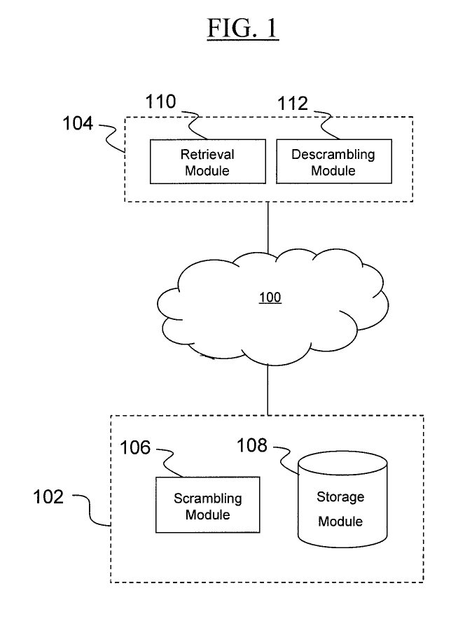

FIG. 1 shows an exemplary network environment according to some embodiments of the technology. The network includes a first computing device 102 communicating to a second computing device 104 via an IP network 100. The first computing device 102 includes a scrambling module 106 for scrambling data in a data file to produce a scrambled data file. The first computing device 102 also includes a storage module 108 for storing the data file and/or the scrambled version of the data file. In some embodiments, at least a portion of the storage module 108 resides in a location external to the first computing device 102. The second computing device 104 includes a retrieval module 110 for retrieving a scrambled data file from the storage module 108 and a descrambling module 112 for descrambling the scrambled data file to obtain the original data file. In some embodiments, the first computing device 102 is controlled by a content provider and the second computing device 104 is controlled by a user of a service offered by the content provider.

The data file or the scrambled data file can be in a digital format such as graphics, executable, audio or zipped. Exemplary content formats include SWF, AVI, DV, JPEG, MPEG, WMV, WAV and MP3. Exemplary content formats can also include EXE, DCR, UNITY3D, FLV, JS, CSS, TGA, MAP, TAG, SAV, LEV, GBX, DEH, DSG, LMP, BSP, PAK, PK2, PK3, PK4, DAT, BIN, and ZIP. In some embodiments, the data file is configured such that it is executable on one or more computing platforms. In some embodiments, the data file is compatible with the Adobe Flash environment.

The scrambling module 106 of the first computing device 102 can encrypt content of the data file using one or more encryption schemes. For example, the scrambling module 106 can supply an input block of n bits of data, such as a data block of 32 bits, to an encryption algorithm that in turn generates an encrypted output data block of size n. The input block can be a portion of a data file stored in the storage module 108. During encryption, the data file can be opened in binary mode for reading only so as to protect the data file from being corrupted by the encryption process. For each input data block of size n, the encryption algorithm can first pseudo-randomize the n bits of data to produce a string of pseudo-randomized bits. In some embodiments, the scrambling module 106 applies a bitwise exclusive disjunction (XOR) operation to a pair of pseudo-randomized bit strings, each corresponding to a block of a data file. Hence, one string acts as an encryption key for the other string and vise versa. The resulting encrypted strings for the data file can be saved in the storage module 108. In some embodiments, the scrambling module 106 XOR together a pseudo-randomized data string and a predetermined encryption key to create an encrypted bit string. The resulting encrypted strings and the encryption key can be saved in the storage module 108. In general, any known encryption schemes can be used to encrypt the content of a data file. In some embodiments, one or more scrambling schemes can be used to scramble a data file to produce a scrambled data file, which can be saved in the storage module 108.

The first computing device 102 can also create a wrapper file corresponding to an encrypted data file. In some embodiments, the wrapper file includes code for identifying the address of the encrypted data file saved in the storage module 108. The address can be in the form of a Uniform Resource Locator (URL), for example. In some embodiments, the wrapper file includes code for decrypting the encrypted data file. For example, the wrapper file can include a decryption key or other decryption instructions to decrypt the encrypted data file. In some embodiments, the wrapper file includes code for descrambling a data file if the data file has been scrambled by the first computing device 102. In addition, the wrapper file can include code to reverse any pseudo-randomization algorithms applied to the data file. The wrapper file can also embed a link to an address in the storage module 108 where decryption-related code or code used to reverse a pseudo-randomization algorithm is stored. In some embodiments, the wrapper file additionally includes a flag that can be set by an operator to indicate whether decryption of the corresponding encrypted data file needs to be performed. After it is generated, the wrapper file can be stored in the storage module 108 or another storage location.

In some embodiments, the first computing device 102 applies one or more known obfuscation algorithms to the decryption-related code in the wrapper file to make the code difficult to understand to humans, thereby deterring tempering or reverse engineering by an intruder. The first computing device 102 can also obfuscate the encrypted data file to provide enhanced data security.

The data file, the encrypted data file, and the wrapper file can be in the same format, such as in the SWF format. In some embodiments, the files are in different formats.

After a wrapper file is created, the first computing device 102 can embed a URL of the wrapper file or an obfuscated version of the wrapper file in a webpage from which the encrypted data file can be accessed and decrypted. The webpage itself can be stored in a web server of the first computing device 102 or at a third-party location. In some embodiments, the first computing device 102 only embeds the address of the wrapper file into a webpage if the webpage has a domain name that is on a white list of accepted domains.

The second computing device 104 can request service of a webpage from a web server over the IP network 100, where the webpage references a wrapper file. As the webpage loads, the retrieval module 110 of the second computing device 104 can retrieve the encrypted data file from the storage module 108 based on the information in the wrapper file. The retrieval module 110 accomplishes this by accessing the wrapper file using an address referenced in the webpage. The wrapper file in turn provides the address of the encrypted data file saved in the storage module 108. For example, the retrieval module 110 can access the wrapper file by loading a URL embedded in the webpage. Upon obtaining the wrapper file, the retrieval module 110 accesses the encrypted data file by loading a URL included in the wrapper file.

The second computing device 104 can store at least one of the wrapper file and the encrypted data file obtained by the retrieval module 110 in a storage location local to the second computing device 104. In some embodiments, a cache buster is associated with the wrapper file or the encrypted data file to prevent the file from being stored locally by the second computing device 104, thereby discouraging an intruder from stealing the file from the local storage. In some embodiments, the wrapper file or the encrypted data file is streamed from a socket, which can prevent an intruder from stealing data by monitoring traffic information between the network 100 and the second computing device 104. To prevent hotlinking, a webpage can also include code to stop the second computing device 104 from accessing the wrapper file or the encrypted data file if the REFERRER header of the request sent by the second computing device 104 does not satisfy certain criteria. For example, access is denied if the second computing device 104 tries to retrieve the webpage from a link in another webpage.

As a webpage is loaded by the second computing device 104, the descrambling module 112 can decrypt the encrypted data file retrieved by the retrieval module 110. The descrambling module 112 accomplishes this by accessing the wrapper file referenced by the webpage, which includes code that provides instructions for decrypting the decrypted data file. The descrambling module 112 can access the wrapper file by loading a URL included in the webpage. In some examples, the wrapper file includes code indicating that data in a data file has been first pseudo-randomized before being encrypted using a XOR operation. Accordingly, the descrambling module 112 decrypts the encrypted data file by XOR together each block of encrypted data of the data file with a corresponding decryption key, which can be written to the wrapper file. The descrambling module 112 then applies an appropriate function, also identified by the wrapper file, to reverse the pseudo-randomization effect on the decrypted data strings, thereby producing the original, unencrypted data file. In some embodiments, the descrambling module 112 retrieves decryption-related information by loading one or more URLs embedded in the wrapper file. In some embodiments, the descrambling module 112 descrambles a scrambled data file based on information in a wrapper file.

The descrambling module 112 may not decrypt the data file retrieved by the retrieval module 108 if a flag in the wrapper file indicates that decryption is not required because, for example, the data file has not been encrypted or the data file should remain encrypted.

The second computing device 104 can store the decrypted data file in a local storage location. The second computing device 104 can allow a web browser to retrieve the decrypted data content from the local storage and present the content via the webpage.

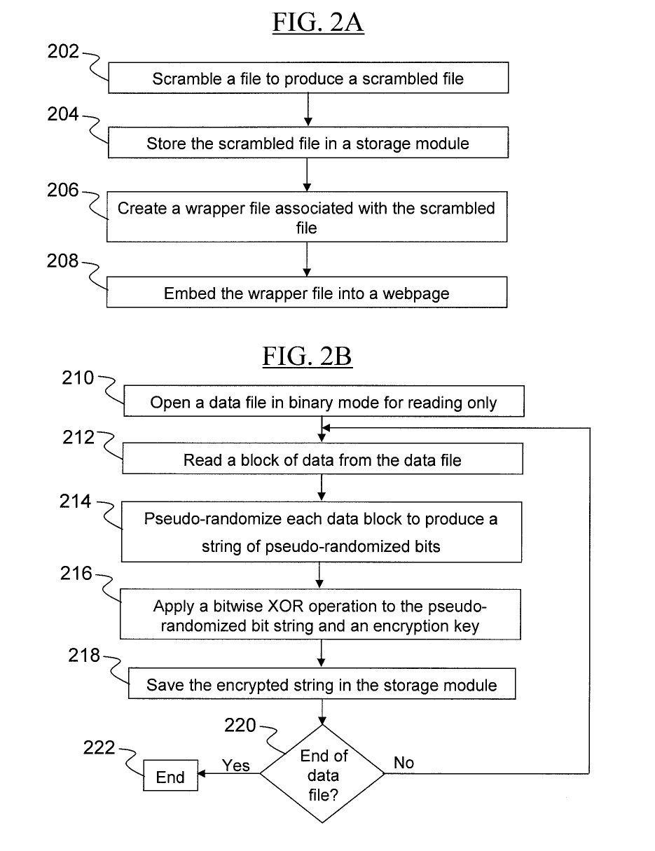

FIG. 2A shows an exemplary process executed by a first computing device 102. The scrambling module 106 of the first computing device 102 first scrambles or encrypts a data file (step 202). The scrambled or encrypted data file can be stored in a storage module 108 of the first computing device 102 (step 204). The first computing device 102 can then create a wrapper file associated with the scrambled or encrypted data file (step 206). The wrapper file includes de-scrambling or decryption-related code and code that identifies the location of the scrambled or encrypted data file. Finally, the first computing device 102 can embed an address or link to the wrapper file in a webpage accessible to a second computing device 104 via the IP network 100 (step 208).

FIG. 2B shows an exemplary process for encrypting the content of a data file, which can be executed by the scrambling module 106 of the first computing device 102. The scrambling module 106 first opens a data file in binary mode for reading only (step 210) and reads at least one block of n bits of data from the data file (step 212). For each data block of size n, the scrambling module 106 first applies an algorithm to pseudo-randomize the n bits of data to produce a string of pseudo-randomized bits (step 214). The scrambling module 106 then applies a bitwise XOR operation to a pseudo-randomized bit string and a corresponding encryption key. In some embodiments, the encryption key is another pseudo-randomized bit string corresponding to a second block of the data file (step 216). Hence, one string acts as an encryption key for the other string and vise versa. The resulting encrypted string for the data file can be saved in the storage module 108 (step 218). If the scrambling module 106 determines that the end of the data file has not been reached (step 220), the scrambling module 106 executes the encryption process (steps 212-218) for the next block of the data file. Otherwise, the scrambling module 106 ends the encryption process (step 222).

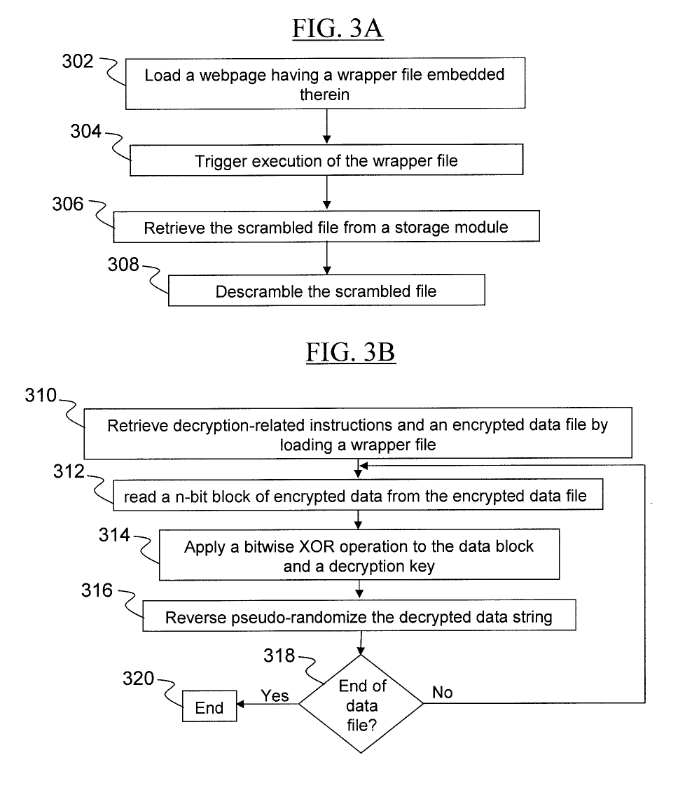

FIG. 3A shows an exemplary process executed by a second computing device 104. The second computing device 104 first loads a webpage referencing a wrapper file, which identifies the location of a scrambled or encrypted data file (step 302). The wrapper file also includes descrambling or decryption instructions. Upon loading the webpage, the retrieval module 110 of the second computing device 104 accesses the wrapper file based on the location identified by the webpage (step 304). From the wrapper file, the retrieval module 110 can then retrieve the scrambled or encrypted data file from the storage module 108 based on its location identified by the wrapper file (step 306). The descrambling module 112 can descramble or decrypt the scrambled or encrypted data file retrieved by the retrieval module 110 using the instructions provided by the wrapper file (step 308).

FIG. 3B shows an exemplary process for decrypting an encrypted data file, which can be executed by the descrambling module 112 of the second computing device 104. The descrambling module 112 can retrieve the encrypted data file, along with decryption-related instructions, by loading a wrapper file (step 310). If the instructions indicate that the original data file was encrypted using the method of FIG. 2B, the descrambling module 112 is adapted to read a n-bit block of encrypted data from the encrypted data file (step 312) and apply a bit-wise XOR operation to the encrypted data block and a corresponding decryption key (step 314). In some embodiments, the decryption key is another block of decrypted data of the original data file. The descrambling module 112 then applies an appropriate function, as identified by the wrapper file, to reverse the pseudo-randomization effect on the decrypted data string (step 316). If the descrambling module 112 determines that the end of the encrypted data file has not been reached (step 318), the descrambling module 112 executes the decryption process (steps 312-316) for the next block of data in the encrypted data file. Otherwise, the descrambling module 112 ends the decryption process (step 320).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOW), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, a Real-time Messaging protocol (RTMP), a Real-time Media Flow Protocol (RTMFP) and/or other communication protocols.

Devices of the computing system can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation).

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method, executed on a computer, for providing content protection to a data file displayed on a webpage, the method comprising:
scrambling, by a scrambling module, data in the data file to produce a scrambled data file;
storing, by a storage module, the scrambled data file; and
embedding, by a computing device, a wrapper file associated with the scrambled data file into the webpage that, upon loading, retrieves the scrambled data file from the storage module and descrambles data in the scrambled data file.

2. The method of claim 1 wherein scrambling the data in the data file comprises encrypting the data.

3. The method of claim 1 wherein descrambling the data in the scrambled data file comprises decrypting the data.

4. The method of claim 1, wherein the wrapper file includes a link to the scrambled data file stored in the storage module.

5. The method of claim 1, wherein the wrapper file includes a descrambling code for descrambling the data in the scrambled data file.

6. The method of claim 5, further comprising obfuscating the wrapper file to conceal the descrambling code.

7. The method of claim 1, wherein at least one of the data file, the scrambled data file, or the wrapper file is in a SWF format.

8. A method, executed on a computer, for providing content protection to a data file displayed on a webpage, the method comprising:
loading, by a computing device, the webpage having a wrapper file embedded therein, the wrapper file is associated with a scrambled data file produced from scrambling data in the data file;
retrieving, by a retrieval module, the scrambled data file from a storage module; and
descrambling, by a descrambling module, data in the scrambled data file.

9. The method of claim 8, further comprising validating that a domain name associated with the webpage is on a list of approved domain names before loading the webpage.

10. The method of claim 8, further comprising preventing execution of the wrapper file from a local cache location.

11. The method of claim 8, further comprising triggering, by an execution module, execution of the wrapper file that initiates the retrieving and the descrambling.

12. A method for providing content protection to a data file displayed on a webpage, the method comprising:
scrambling, by a scrambling module, data in the data file to produce a scrambled data file;
storing, by a storage module, the scrambled data file;
embedding, by a first computing device, a wrapper file associated with the scrambled data file into the webpage;
loading, by a second computing device, the webpage;
retrieving, by a retrieval module, the scrambled data file from the storage module; and
descrambling, by a descrambling module, data in the scrambled data file.

13. A computing system for providing content protection to a data file displayed on a webpage, the computing system comprising:
a scrambling module for scrambling data in the data file to produce a scrambled data file;
a storage module for storing the scrambled data file; and
a computing device for embedding a wrapper file associated with the scrambled data file into the webpage that, upon loading, retrieves the scrambled data file from the storage module and descrambles data in the scrambled data file.

14. A computing system for providing content protection to a data file displayed on a webpage, the computing system comprising:
a computing device for loading the webpage having a wrapper file embedded therein, the wrapper file is associated with a scrambled data file produced from scrambling data in the data file;
a retrieval module for retrieving the scrambled data file from a storage module; and
a descrambling module for descrambling data in the scrambled data file.

15. The system of claim 14, wherein the retrieval module retrieves the scrambled data file based on a link to the scrambled data file included in the wrapper file.

16. The system of claim 14, wherein the descrambling module uses a descrambling code of the wrapper file to descramble the data in the scrambled data file.

17. The system of claim 14, further comprising an execution module for executing the wrapper file, the execution module comprises the retrieval module and the descrambling module.

18. A computer program product, tangibly embodied in a non-transitory computer readable medium, for providing content protection to a data file displayed on a webpage, the computer program product including instructions being operable to cause data processing apparatus to:
scramble data in the data file to produce a scrambled data file;
store the scrambled data file in a storage module; and
embed a wrapper file associated with the scrambled data file into the webpage that, upon loading, retrieves the scrambled data file from the storage module and descrambles data in the scrambled data file.

19. A computer program product, tangibly embodied in a non-transitory computer readable medium, for providing content protection to a data file displayed on a webpage, the computer program product including instructions being operable to cause data processing apparatus to:
load the webpage having a wrapper file embedded therein, the wrapper file is associated with a scrambled data file produced from scrambling data in the data file;
retrieve the scrambled data file from a storage module; and
descramble data in the scrambled data file.
